(19) United States
(12) Patent Application Publication
(10) Pub. No.: US 2020/0094820 A1
(43) Pub. Date: Mar. 26, 2020

(54) AUTOMATICALLY ASSESSING AND REDUCING VEHICULAR INCIDENT RISK

(71) Applicant: Element AI Inc., Montreal (CA)

(72) Inventors: Charles Patrick DUGAS, Montreal (CA); Robert John RIVERSO, Montreal (CA); Carlos BENFEITO, Montreal (CA)

(21) Appl. No.: 16/576,374

(22) Filed: Sep. 19, 2019

Related U.S. Application Data
(60) Provisional application No. 62/734,383, filed on Sep. 21, 2018.

(51) Int. Cl. B60W 30/09; G07C 5/08; G05B 13/02; G06N 3/04; B60Q 9/00; B60W 30/095

(52) U.S. Cl. CPC B60W 30/09; G07C 5/085; G05B 13/027; B60W 2550/40; B60Q 9/008; B60W 30/0956; G06N 3/0472

(57) ABSTRACT

Systems and methods for automatic, near real-time detection of an increased risk that a specific vehicle will be imminently involved in an incident, and for taking automatic, near real-time actions to attempt to reduce that risk. At least one sensor gathers data related to a specific vehicle and/or its occupant(s). The data is then transmitted to a data processing unit, which uses a risk factor identification module to detect an increase in the risk that an incident is imminent. If that risk has increased, the system takes at least one preventive action to attempt to reduce that risk. The preventive action is determined using an incident prevention module, and may comprise communicating with the vehicle's driver, with the specific vehicle itself, and/or with external response teams. External data may also be used to identify risk factors. The risk factor identification module may comprise a neural network and/or a database.

### RELATED APPLICATIONS

This is a US non provisional patent application which claims the benefit of U.S. provisional application No. 62/734,383 filed on Sep. 21, 2018.

### TECHNICAL FIELD

The present invention relates to preventing vehicular incidents. More specifically, the present invention relates to automatically detecting the risk of an imminent incident and to automatically taking actions to attempt to reduce that risk.

### BACKGROUND

Vehicular incidents (also called ‘accidents’, ‘crashes’, or ‘collisions’) represent potential damage to vehicles, to other property (including, without limitation, owned objects, owned animals, and land), and to people. Each incident thus represents a potential cost to an insurer. Even incidents that do not involve injury carry associated costs which can reach tens of thousands of dollars. Vehicle repair and replacement is often expensive, and the costs are frequently exacerbated by delays. Additionally, many incidents disrupt traffic flows and inconvenience other drivers, resulting in lost productivity, infrastructure strain, and frustration.

Moreover, of course, incidents often involve serious and even fatal injury to the drivers and other occupants of the vehicles involved, as well as to cyclists and pedestrians. In the US, the National Highway Traffic Safety Administration (NHTSA) reports that the number of roadway deaths has increased in the past several years and exceeded 37,000 in 2016. The World Health Organization reports that, worldwide, 3,400 people die in vehicular incidents each day. Clearly, there is a need for systems and methods that can reduce the number and severity of vehicular incidents.

Many programs and systems already exist that seek to proactively reduce the probability of incidents. As one example, most countries have drivers' education and licensing programs. These programs generally attempt to teach safer driving habits and ensure that unqualified drivers are not allowed on the roads. Relatedly, requirements for vehicle insurance can encourage safer driving, as safer drivers typically pay lower premiums. As a more active example, police in many regions operate traffic law enforcement programs, issuing tickets for reckless or careless driving, and, in some cases, even impounding the vehicles of dangerous drivers. Additionally, many roadway construction and development projects incorporate “traffic calming measures”, such as speedbumps, central islands, and curves. Further, in recent years, many new in-vehicle safety features have been developed and deployed.

Yet as the increasing roadway death count shows, these programs and features are not sufficient. Although traffic enforcement can be effective, “speed traps”, roadblocks, and other enforcement methods are generally highly localized and easily avoided by drivers. Many of the other approaches (drivers' education and insurance, in particular) rely on the self-interest and good judgement of drivers. As is well-known, however, most people consider their own skills, including their driving skills, to be above average (see, for instance, Roy & Liersch, “I Am a Better Driver Than You Think: Examining Self-Enhancement for Driving Ability”, Journal of Applied Social Psychology 43(8), 2013, the entirety of which is herein incorporated by reference). A careless driver who believes himself to be highly skilled may not be able to accurately assess the risks in a particular situation.

Thus, there is a clear need for systems and methods that can proactively assess the probability of an incident occurring and that can take steps to reduce that probability, with or without the driver's involvement. These systems and methods would preferably operate in real-time or near-real-time.

### SUMMARY

The present invention provides systems and methods for automatic, near real-time detection of an increased risk that a specific vehicle will be imminently involved in an incident, and for taking automatic, near real-time actions to attempt to reduce that risk. At least one sensor gathers data related to a specific vehicle and/or its occupants. The data is then transmitted to a data processing unit, which uses a risk factor identification module to detect an increase in the risk that an incident is imminent. If that risk has increased, the system takes at least one preventive action to attempt to reduce that risk. The preventive action is determined using an incident prevention module, and may comprise communicating with the vehicle's driver, with the specific vehicle itself, and/or with external response teams. External data may also be used to identify risk factors. The risk factor identification module may comprise a neural network and/or a database.

In a first aspect, the present invention provides a method for detecting an increase in a probability that a specific vehicle will be imminently involved in an incident, and for taking at least one action to attempt to decrease said probability, said method comprising the steps of:
(a) receiving, in near real-time, vehicle-related data from at least one sensor, wherein said vehicle-related data is related to a condition or operation of said specific vehicle;
(b) analyzing said vehicle-related data, in near real-time, to detect said increase in said probability; and
(c) taking said at least one action, in near real-time, to attempt to decrease said probability,
   wherein said incident involves a risk of damage to at least one of: said specific vehicle; other vehicles; people; and property.

In a second aspect, the present invention provides a system for detecting an increase in a probability that a specific vehicle will be imminently involved in an incident, and for taking at least one action to attempt to decrease said probability, said system comprising:
at least one sensor for collecting vehicle-related data, wherein said vehicle-related data is related to a condition or operation of said specific vehicle;
a server for receiving said vehicle-related data from said at least one sensor;
a processor in operative communication with said server, said processor being for analyzing said vehicle-related data;
a risk factor identification module for identifying risk factors in said vehicle-related data, wherein each of said risk factors causes said probability to increase, and wherein said processor thereby uses said risk factor identification module to detect said increase in said probability; and
an incident prevention module for determining said at least one action to be taken, wherein, based on a result from said incident prevention module, said processor directs said server to cause said at least one action to be taken,
   wherein said vehicle-related data is received and analyzed in near real-time, and
   wherein said incident involves a risk of damage to at least one of: said specific vehicle; other vehicles; people; and property.

In a third aspect, the present invention provides non-transitory computer-readable media having encoded thereon computer-readable and computer-executable instructions that, when executed, implement a method for detecting an increase in a probability that a specific vehicle will be imminently involved in an incident, and for taking at least one action to attempt to decrease said probability, said method comprising the steps of:
(a) receiving, in near real-time, vehicle-related data from at least one sensor, wherein said vehicle-related data is related to a condition or operation of said specific vehicle;
(b) analyzing said vehicle-related data, in near real-time, to detect said increase in said probability; and
(c) taking said at least one action, in near real-time, to attempt to decrease said probability,
   wherein said incident involves a risk of damage to at least one of: said specific vehicle; other vehicles; people; and property.

### BRIEF DESCRIPTION OF THE DRAWINGS

The present invention will now be described by reference to the following figures, in which identical reference numerals refer to identical elements and in which:

FIG. 1 is a diagram of a vehicle showing possible sensor locations;

FIG. 2 is a block diagram of a system according to one aspect of the invention;

FIG. 3 is a block diagram of another embodiment of the system of FIG. 2;

FIG. 4 is a block diagram of another embodiment of the system of FIG. 2; and

FIG. 5 is a flowchart illustrating a method according to another aspect of the invention.

### DETAILED DESCRIPTION

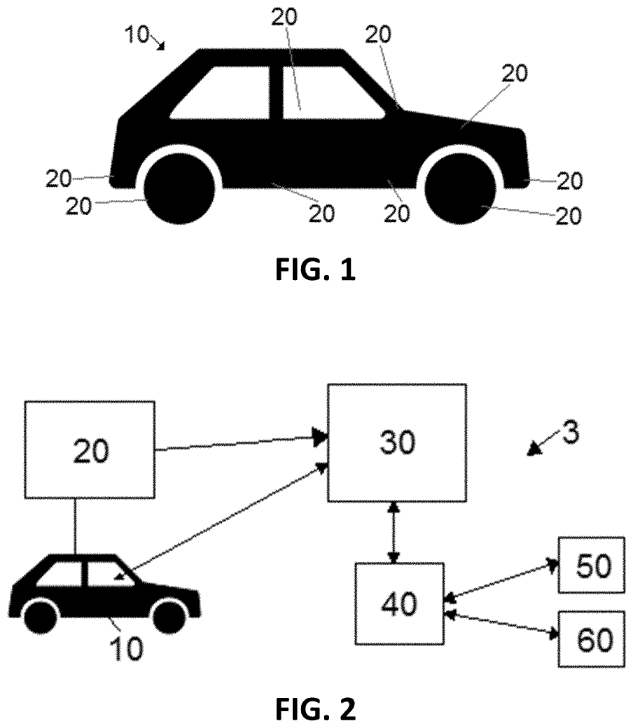

The present invention provides systems and methods for automatic, near real-time detection of an increased risk that a specific vehicle will be imminently involved in an incident, and for taking automatic and near real-time actions to attempt to reduce that risk. Referring first to FIG. 1, a diagram of a vehicle 10 is shown. This vehicle 10 is equipped with multiple sensors 20. Each of the sensors 20 collects data related to the condition or operation of the vehicle 10. As an example, one of the sensors 20 may collect data related to the structural integrity of the vehicle 10 (i.e., to the vehicle 10's condition), while another of the sensors 20 may collect data related to the vehicle 10's speed (i.e., to the vehicle 10's operation). Of course, some sensors may collect data that is related to both condition and operation. For instance, a sensor may collect engine temperature data.

The sensors 20 in FIG. 1 are shown in potential and exemplary locations on the vehicle 10. For example, FIG. 1 indicates potential placement of sensors on: the rear bumper; a rear wheel; the vehicle's undercarriage; a front side door; a front wheel; the front bumper; ‘under’ the vehicle's hood (i.e., connected to the engine); on or within the vehicle's dashboard; and within the interior of the vehicle. These are only intended to indicate possible locations. Depending on the implementation, a vehicle 10 may have sensors 20 at any of these locations, or at none of these locations. As would be clear to the person of skill in the art, the sensors 20 may be in any location or configuration that allows them to collect the desired vehicle-related data.

In some cases, a sensor 20 may be coupled to the vehicle 10, either to its exterior or interior, and configured to monitor conditions external to the vehicle. As an example, such a sensor might include an ‘exterior rear proximity sensor’ to detect objects close to the vehicle's rear bumper. Other sensors 20 may be coupled to an internal component of the vehicle 10. For instance, a sensor may be directly coupled to a piston within the vehicle's engine. Such a sensor would collect piston-related data. As another alternative, data may be obtained from sensors on devices within the vehicle 10. For instance, acceleration data for the vehicle 10 could be obtained from an accelerometer on a mobile computing device belonging to an occupant of the vehicle 10. As another example, a sensor could be attached to or built into the driver's key fob. Such a sensor could be configured to collect data only when the engine of the vehicle 10 is active.

In a preferred implementation, every individual part and component of the vehicle 10 would be coupled to a separate sensor. This would allow significant amounts of data to be gathered and analyzed. However, any number of sensors 20 may be used. In some cases, there may only be a single sensor 20 used on a certain vehicle 10. For instance, data related to acceleration may be sufficient to predict an imminent incident: a pattern of rapid decelerations may indicate that the driver is not paying attention to heavy traffic in their surroundings. Such a pattern would likely increase the risk of an imminent incident.

Additionally, in some embodiments of the invention, sensors 20 may be configured to monitor the driver and passengers of the vehicle. These sensors would thus gather data regarding the occupant(s) of the specific vehicle. Such ‘occupant-related data’ can be useful in predicting incidents. That is, such data may be useful in identifying dangerous driving habits or conditions of the driver (e.g., distraction, drowsiness) before those habits and conditions lead to potentially dangerous changes in the vehicle's motion. As an example, ‘gaze tracking’ sensors, known in the art, can track the eye motion of a vehicle's driver and can detect if the driver falls asleep, is drowsy or distracted, or is ‘zoning out’. The present invention may use data from such sensors or any other sensors that gather information related to occupant(s) of the specific vehicle, including without limitation, heart rate sensors, breathing sensors, gaze tracking sensors, and physical positioning sensors (e.g., sensors that monitor the position of a driver's hand on the steering wheel).

In some embodiments, the sensors 20 may transmit data at specific intervals (e.g., every five seconds). However, road conditions may change rapidly. Thus, with such interval-based embodiments, there is a risk that the system will not be able to respond to changing conditions fast enough to prevent an incident. Thus, it is generally preferable that the sensors 20 transmit continuous streams of data to the data processing unit 30.

It should additionally be clear that the car shown in FIG. 1 is merely exemplary. The system of the present invention may be applied to any kind of land vehicle, including without limitation: sedans; hatchbacks; coupes; convertibles; motorcycles; cargo vehicles; sport utility vehicles; recreational vehicles; inland marine vehicles; minivans; trucks of any kind; and buses.

Referring now to FIG. 2, a block diagram of a system 3 according to one aspect of the invention is illustrated. Sensors 20 collect data related to the vehicle 10 and transmit that vehicle-related data to a data processing unit 30. The data processing unit 30 performs an analysis of the vehicle-related data using a risk factor identification module 50. Each risk factor (as an example, speeds over 100 km/h) causes an increase in the probability that the vehicle 10 will be imminently involved in an incident. Of course, the size of that increase will depend on the specific risk factor itself. That is, though speeds over 100 km/h would cause an increase in the risk of imminent incident, speeds over 140 km/h would likely cause a greater increase. Thus, based on this analysis, the data processing unit 30 detects whether that probability has increased. If there has been an increase (i.e., if the risk factor identification module 50 identifies one or more risk factors in the vehicle-related data), the data processing unit 30 then uses an incident prevention module 60 to determine at least one preventive action to be taken to attempt to reduce that risk. The data processing unit 30 will then direct the data processing unit 30 to take the preventive action(s). To this end, the data processing unit 30 may communicate with the vehicle 10's driver and/or with the vehicle 10 itself.

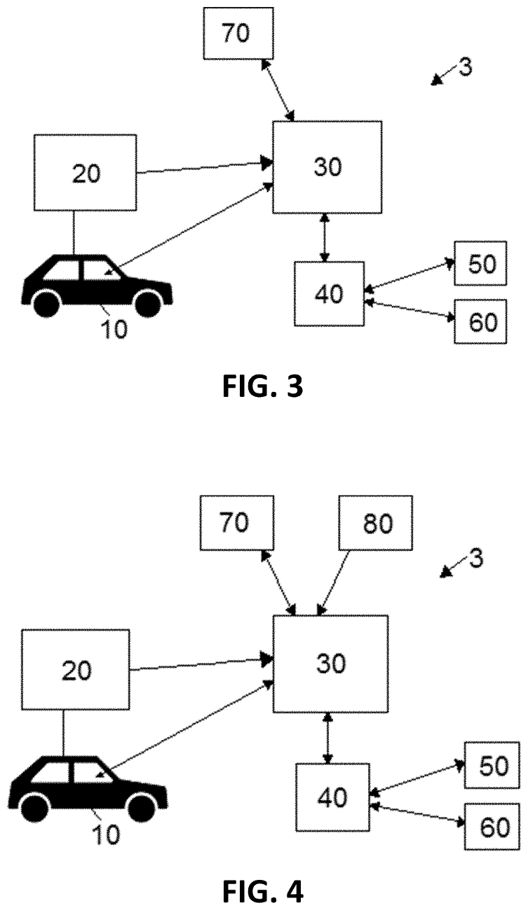

FIG. 3 is a block diagram showing another embodiment of the system 3. This embodiment is similar to the embodiment shown in FIG. 2, differing in only two respects. In the first place, the vehicle-related data in this embodiment is stored in a database 40 before being processed by the data processing unit 30. Data may, of course, also be stored after being processed by the data processing unit 30. For instance, the outcome of a certain data pattern might be stored with that data pattern, and be used as the basis for later analysis. That is, if the risk factor identification module 50 determined that a certain data pattern indicated an incident, that determination could be stored in the database and related to that data pattern, for future reference. Additionally, in an implementation wherein the risk factor identification module 50 comprises a neural network, this stored data may be used as the basis for a training set for use in training later versions of the neural network model. An embodiment of the invention that uses such a database 40 may thus be preferable for some uses. In the second place, the data processing unit 30 in this embodiment of the invention may communicate with external response teams 70, as will be discussed in more detail below. Note, of course, that there is no necessary connection between the database 40 and the external response teams 70: that is, some embodiments of the invention may use a database 40 and not communicate with external response teams 70; some embodiments of the invention may communicate with external response teams 70 but not use a database 40; and some embodiments of the invention may do both.

As would be clear to the person skilled in the art, the data processing unit 30 may be implemented in many different forms. As examples, the data processing unit 30 may comprise: a server and one or more processors; a computing unit that resides on an off-site server; an in-vehicle computing unit; and/or systems that employ distributed computing methods, including the well-known ‘cloud’ (semi-centralized) and ‘fog’ (edge device) computing methods. Further, in multi-processor implementations, data may be processed by multiple processors in parallel. Additionally, different processors may process different portions of the data.

The sensors 20 may also process the vehicle-related data they gather, before transmitting that data to the data processing unit 30. That is, there may be some processing of the vehicle-related data in the vehicle itself. This approach may be useful in some scenarios. For instance, large video files gathered by a dashboard camera could be compressed before being transmitted to the data processing unit 30. As another example, the sensors 20 may be configured to reduce noise in the vehicle-related data. Other such techniques that are well-known in the art of data processing and transmission may likewise be applied at the sensor side. In some implementations of this approach, the sensors 20 may be connected to a vehicle-side processing unit that processes the data for sending and then transmits that processed data to the data processing unit 30.

The vehicle-related data is transmitted through the system 3 in near real-time, and is also processed in near real-time. As is well known in the art, the term “near real-time” takes into account unavoidable time delays in real-time signals. These time delays are necessarily introduced by automated processing and by data transmission. In general, these time delays are insignificant and have little or no impact on the outcome of the process. The absolute real-time duration of these delays may vary depending on the implementation and the context.

Additionally, the term ‘imminent’, as used herein, refers to the relatively near future. That is, it refers to near real-time conditions and to predictions generally covering a few minutes. The precise absolute time duration of the term ‘imminent’ depends on many contextual factors, including the speed of travel. Generally, however, imminent incidents are those that may still be prevented or at least mitigated.

The analysis performed by the data processing unit 30, using the risk factor identification module 50, may take many forms. The form of the analysis may depend on the type and volume of data received, on the sensors 20 used, on the specific vehicle being analyzed, and on the user's preferences. Referring to the example above, if the data processing unit 30 receives a single stream of acceleration data, the risk factor identification module 50 may be configured to recognize rapid decelerations only. In this example, the risk factor identification module 50 may compare each deceleration to a threshold value that indicates the amount of time in which a normal (i.e., non-incident) deceleration would occur. If the durations of multiple decelerations within a certain period in the data stream are each smaller than that threshold value, the risk factor identification module 50 would report that an imminent incident is likely. The threshold value can be a predetermined number.

However, as mentioned above, it is preferable to have multiple streams and sources of data related to the specific vehicle. In fact, it is preferable to have as many data sources as possible. Further, as would be clear to the person skilled in the art, there are many different possible risk factors that would increase the risk of an imminent incident, including, without limitation, high or low speeds, lane drifting or weaving, and driver distraction.

Additionally, risk factors for an incident generally vary by vehicle. For instance, a vehicle with a small turning radius (e.g., a hatchback) may be able to take a turn at a higher speed than a vehicle with a large turning radius (e.g., a panel van). Turn speeds above a certain threshold may be safe for the hatchback but significantly increase the risk that the panel van will be involved in an incident. Moreover, risk factors may interact with each other to further increase the risk of imminent incident. As an example, the risk increase associated with high-speed travel may be more substantial in heavy traffic. Alternatively, heavy traffic may also increase risks associated with low-speed travel (that is, if the specific vehicle is travelling slowly compared to surrounding traffic, its risk of incident increases). Thus, the surrounding traffic conditions and the vehicle's speed can interact in ways that are not always predictable.

Thus, risk factors may also depend on external data—that is, on data from a source that is unrelated to the condition or operation of the vehicle 10. As an example, weather conditions such as rain may make an ordinarily safe driving habit dangerous. FIG. 4 illustrates a system 3 wherein the risk factor identification module 50 uses external data from external sources 80 when identifying risk factors. As examples, such external sources may include meteorological information databases, traffic cameras, and data on current traffic levels. Clearly, external data may be unpredictable. For this and other reasons, determining predetermined values for each possible risk factor would be time-consuming and often difficult.

Therefore, in a preferred implementation, the data processing unit 30 uses the risk factor identification module 50 to compare the specific vehicle's data to historical operation data. This historical operation data may comprise data from the specific vehicle itself and from other similar vehicles. The historical operation data typically comprises data gathered while the specific vehicle or similar vehicles were in normal operating conditions. If available, also, the historical operation data may comprise data gathered during and after previous known incidents involving these vehicles, and, in particular, data gathered when such known incidents were imminent. Such comparisons would allow the risk factor identification module 50 to more accurately detect conditions and factors that are likely to lead to incidents, and thus to determine whether the probability of an imminent incident has increased. Additionally, in some embodiments, the risk factor identification module 50 also predicts the probable severity of a probable imminent incident, based on comparisons to historical operation data.

In one implementation of this comparison analysis, the risk factor identification module 50 comprises a neural network that has been trained on historical operation data. As would be clear to the person skilled in the art, the training set of historical operation data could include data from many different vehicles and kinds of vehicles, in normal operating conditions, in incident conditions, and in conditions that led to previous known incidents. The neural network would be trained, based on this training data, to automatically identify data patterns in the specific vehicle's data that increase the probability of an incident.

In another implementation of the comparison analysis, the risk factor identification module 50 may be a rules-based module. In this implementation, the risk factor identification module 50 is connected to a database or other data store that contains the historical operation data. Such an implementation may be preferred over the neural network implementation, described above, by some users for some purposes. However, the neural network implementation is generally preferable.

Further, the detection of an ‘increase’ in risk can take many forms. In one implementation, the risk factor identification module 50 may determine the ‘current risk level’ and compare that current risk level to a prior risk level, to determine if the current risk level is elevated. In another implementation, the risk factor identification module 50 may determine the ‘current risk level’ and compare that current risk level to an average or default risk level. Such an average risk level could be based on the prior history of the specific vehicle 10 or similar vehicles in similar conditions. Alternatively, the average risk level could be set at a predetermined level, e.g., 30%.

Additionally, in some cases, an increase in risk may not merit preventive action. That is, if the risk of an imminent incident has risen from 10% to only 12%, preventive actions may not be necessary. However, if the risk of an imminent incident has risen from 10% to 80%, preventive actions are likely to be needed. Thus, in some implementations, the risk factor identification module 50 may use a predetermined increase threshold to determine whether an increase in risk is substantial enough to warrant preventive action. For instance, if the increase threshold was set at 15%, any increase larger than 15% would be reported as a ‘true increase’ meriting preventive action. Any increase smaller than 15%, in this scenario, would not be considered an increase. In other implementations, the determination of ‘sufficient increase’ may be made by the incident prevention module 60. That is, in some cases, the incident prevention module 60 may determine that, although the risk of imminent incident has increased, that increase is not significant enough to warrant preventive action.

Again, once an increase in the risk of imminent incident is detected, the data processing unit 30 uses the incident prevention module 60 to determine an appropriate preventive action. For instance, the risk factor identification module 50 may determine that the risk of imminent incident is elevated because the driver of the vehicle 10 is speeding. The data processing unit 30 would then use the incident prevention module 60 to select a preventive action that is intended to reduce the speed of the vehicle 10, and/or to induce the driver to do so. Such an action might comprise sending a warning message to the driver. Such a message may, in some implementations, be sent via a personal mobile computing device belonging to the driver. However, as the use of such devices is, generally, an incident risk factor in itself, a warning message would be preferably sent via an in-vehicle communication system and be displayed on an in-vehicle display. In some implementations, such messages could be sent to the driver via visual, graphical, and/or head-up display systems. In other implementations, depending on the vehicle's configuration, natural user interfaces such as audio messages and voice recognition systems may be used. In still other implementations, visual driver monitoring interfaces may be used to communicate with the vehicle's occupant(s).

Depending on the implementation, preventive actions may also comprise direct communication with the vehicle 10 and/or its components. For instance, some vehicles may include speed limiter and/or speed governor modules. In the example above, based on the risk factor analysis, the incident prevention module 60 may determine that the appropriate action is to issue a control signal to activate that speed limiter module, and thereby reduce the vehicle 10's speed without the involvement of the driver. Alternatively, if the risk identification module 50 identifies high speed, heavy traffic, and a red light ahead, the incident prevention module 60 may direct the system 3 to safely activate the vehicle 10's brakes. Of course, such an implementation may not be desired by all users or in all situations (for instance, by police officers involved in a chase). Thus, it would be preferable to allow a user to deactivate this direct automatic governance of the vehicle 10.

Also, as mentioned above, these preventive actions may include communicating with external response teams (70 in FIG. 3). Such external response teams may include a law and/or traffic enforcement team, such as a police unit. In such a case, the system 3 may inform the police unit of the vehicle 10's location and general risk factors (e.g., weaving between lanes at high speeds). In some embodiments, the system 3 could also inform the police unit of the probability of imminent incident. The law enforcement team could then locate the vehicle 10 and take actions to prevent an incident and/or reduce its impact.

Further, if there is a very high probability of imminent incident, the system 3 may proactively inform other external response teams. For instance, based on the risk factor identification module 50's analysis, a vehicle may have a greater than 99% chance of being involved in an incident causing serious injury within the next 15 seconds. In such a case, although the system 3 may take actions intended to prevent that incident from occurring, those actions may not be entirely successful. Thus, proactively alerting incident response teams may be useful. Such response teams may include (without limitation): emergency response teams, such as fire trucks and/or emergency medical teams; incident management teams, such as tow trucks; and damage mitigation teams, such as mechanics. Other incident management teams may include Traffic Control Centres that can divert traffic away from incident sites. Additionally, damage mitigation teams may include vehicular insurance-related teams. Further, of course, law enforcement teams may also be proactively notified for their ‘response’ capacity, rather than as ‘preventers’. Such proactive response capacity would allow response teams to respond quickly to incidents, potentially reducing the incidents' impacts. Particularly in scenarios that require emergency medical attention, alerting medical teams early and even proactively can potentially save lives.

Of course, even when there is an extremely high probability of an incident, circumstances may change such that the incident does not occur. In such a case, proactive responses may not be needed, and may even be a waste of responder resources. Thus, it is preferable that ‘proactive response’ actions be followed by additional verification steps. These verification steps may comprise analysis of later vehicle-related data, external observation of the specific vehicle 10, and/or direct communication with the occupant(s) of the specific vehicle 10.

Additionally, the incident prevention module 60 may select multiple actions to reduce the risk of a single incident. In some cases, these actions may be performed sequentially. For instance, in the speeding example above, a first action could be a warning message to the driver, alerting them to their vehicle's speed. If the risk does not decrease after that warning, a secondary message could be sent. This secondary message could warn the driver of next steps. For instance, the secondary message could inform the driver that, unless they slow down, their brakes will be automatically activated. Alternatively, the message could indicate that, unless the vehicle slows within a certain time period, the system will alert an external response team. In other cases, multiple actions may be performed simultaneously. For instance, multiple external response teams might be proactively alerted to a likely incident, even while the system 3 takes actions intended to prevent the incident from occurring.

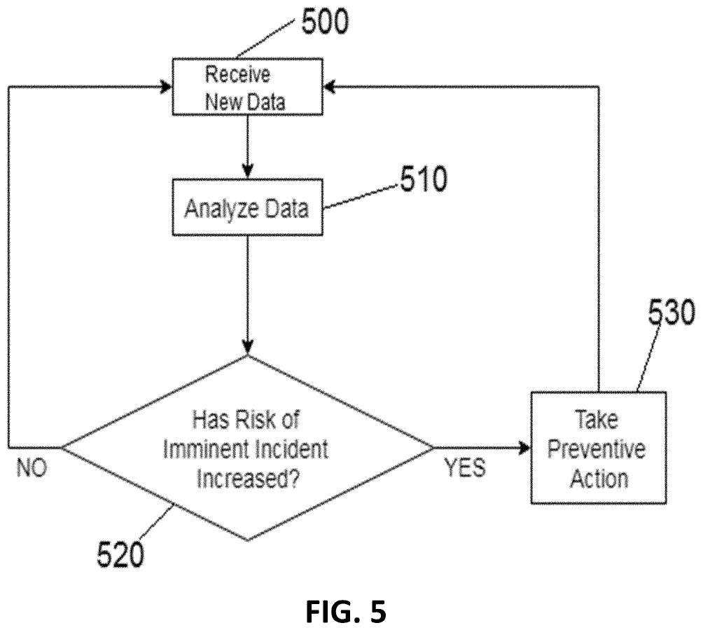

Referring now to FIG. 5, a flowchart detailing a method according to one aspect of the invention is illustrated. At step 500, the method begins by receiving vehicle-related data. This vehicle-related data is then analyzed (step 510). Based on that analysis, the risk of an imminent incident is assessed at step 520. If that risk has not increased, the method returns to step 500 and new vehicle-related data is received. However, if the risk of an imminent incident has increased, at least one preventive action is taken at step 530, to attempt to reduce that risk. The method then returns to step 500, where new data is received. As mentioned above, this is preferably a continuous process. In fact, it is preferred that new vehicle-related data be continuously received at all times when the specific vehicle is in operation.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for detecting an increase in a probability that a specific vehicle will be imminently involved in an incident, and for taking at least one action to attempt to decrease said probability, said method comprising the steps of:
(a) receiving, in near real-time, vehicle-related data from at least one sensor, wherein said vehicle-related data is related to a condition or operation of said specific vehicle;
(b) analyzing said vehicle-related data, in near real-time, to detect said increase in said probability; and
(c) taking said at least one action, in near real-time, to attempt to decrease said probability,
wherein said incident involves a risk of damage to at least one of: said specific vehicle;
other vehicles; people; and property.

2. The method according to claim 1, wherein said at least one sensor comprises at least one of:
a sensor coupled to said specific vehicle and configured to monitor conditions external to said specific vehicle;
a sensor coupled to an internal component of said specific vehicle; and
a sensor on a device within said specific vehicle.

3. The method according to claim 1, wherein step (b) comprises comparing said vehicle-related data to historical operation data, wherein said historical operation data comprises at least one of:
data from said specific vehicle while operating under normal operating conditions;
data gathered from said specific vehicle prior to a previous known incident involving said specific vehicle;
data from vehicles similar to said specific vehicle, gathered from said vehicles while operating under normal operating conditions; and
data from vehicles similar to said specific vehicle, gathered from said vehicles prior to previous known incidents involving said vehicles.

4. The method according to claim 1, wherein external data is used in step (b), said external data being from a data source unrelated to a condition or operation of said specific vehicle.

5. The method according to claim 1, wherein said at least one action comprises at least one of:
sending a message to a driver of said specific vehicle;
sending a control signal to said specific vehicle; and
communicating with at least one external response team.

6. The method according to claim 1, further including the step of proactively alerting an external response team to said probability, wherein said external response team is at least one of: an emergency response team; a law enforcement team; an incident management team; and a damage mitigation team.

7. The method according to claim 1, wherein step (b) is performed using a neural network.

8. The method according to claim 1, wherein said vehicle-related data further comprises data regarding at least one occupant of said specific vehicle.

9. A system for detecting an increase in a probability that a specific vehicle will be imminently involved in an incident, and for taking at least one action to attempt to decrease said probability, said system comprising:
at least one sensor for collecting vehicle-related data, wherein said vehicle-related data is related to a condition or operation of said specific vehicle;
a data processing unit for receiving said vehicle-related data from said at least one sensor and for analyzing said vehicle-related data;
a risk factor identification module for identifying risk factors in said vehicle-related data, wherein each of said risk factors causes said probability to increase, and wherein said data processing unit thereby uses said risk factor identification module to detect said increase in said probability; and
an incident prevention module for determining said at least one action to be taken, wherein, based on a result from said incident prevention module, said data processing unit causes said at least one action to be taken,
wherein said vehicle-related data is received and analyzed in near real-time, and
wherein said incident involves a risk of damage to at least one of: said specific vehicle; other vehicles; people; and property.

10. The system according to claim 9, wherein said at least one sensor comprises at least one of:
a sensor coupled to said specific vehicle and configured to monitor conditions external to said specific vehicle;
a sensor coupled to an internal component of said specific vehicle; and
a sensor on a device within said specific vehicle.

11. The system according to claim 9, wherein said risk factor identification module compares said vehicle-related data to historical operation data, wherein said historical operation data comprises at least one of:
data from said specific vehicle while operating under normal operating conditions;
data gathered from said specific vehicle prior to a previous known incident involving said specific vehicle;
data from vehicles similar to said specific vehicle, gathered from said vehicles while operating under normal operating conditions; and
data from vehicles similar to said specific vehicle, gathered from said vehicles prior to previous known incidents involving said vehicles.

12. The system according to claim 9, wherein said risk factor identification module uses external data when identifying said risk factors, said external data being from a data source unrelated to a condition or operation of said specific vehicle.

13. The system according to claim 9, wherein said at least one action comprises at least one of:
sending a message to a driver of said specific vehicle;
sending a control signal to said specific vehicle; and
communicating with at least one external response team.

14. The system according to claim 9, wherein said data processing unit proactively alerts at least one external response team to said probability, and wherein said at least one external response team is at least one of: an emergency response team; a law enforcement team; an incident management team; and a damage mitigation team.

15. The system according to claim 9, wherein said risk factor identification module comprises a neural network.

16. The system according to claim 9, wherein said vehicle-related data further comprises data regarding at least one occupant of said specific vehicle.

17. Non-transitory computer-readable media having encoded thereon computer-readable and computer-executable instructions that, when executed, implement a method for detecting an increase in a probability that a specific vehicle will be imminently involved in an incident, and for taking at least one action to attempt to decrease said probability, said method comprising the steps of:
(a) receiving, in near real-time, vehicle-related data from at least one sensor, wherein said vehicle-related data is related to a condition or operation of said specific vehicle;
(b) analyzing said vehicle-related data, in near real-time, to detect said increase in said probability; and
(c) taking said at least one action, in near real-time, to attempt to decrease said probability,
wherein said incident involves a risk of damage to at least one of: said specific vehicle; other vehicles; people; and property.

18. The non-transitory computer-readable media according to claim 17, wherein said at least one sensor comprises at least one of:
a sensor coupled to said specific vehicle and configured to monitor conditions external to said specific vehicle;
a sensor coupled to an internal component of said specific vehicle; and
a sensor on a device within said specific vehicle.

19. The non-transitory computer-readable media according to claim 17, wherein step (b) comprises comparing said vehicle-related data to historical operation data, wherein said historical operation data comprises at least one of:
data from said specific vehicle while operating under normal operating conditions;
data gathered from said specific vehicle prior to a previous known incident involving said specific vehicle;
data from vehicles similar to said specific vehicle, gathered from said vehicles when while operating under normal operating conditions; and
data from vehicles similar to said specific vehicle, gathered from said vehicles prior to previous known incidents involving said vehicles.

20. The non-transitory computer-readable media according to claim 17, wherein external data is used in step (b), said external data being from a data source unrelated to a condition or operation of said specific vehicle.
